(19) United States
(12) Patent Application Publication
(10) Pub. No.: US 2017/0272961 A1
(43) Pub. Date: Sep. 21, 2017

(54) WIRELESS COMMUNICATION DEVICE, WIRELESS COMMUNICATION METHOD, AND NON-TRANSITORY COMPUTER READABLE MEDIUM

(71) Applicant: KABUSHIKI KAISHA TOSHIBA, Minato-ku (JP)

(72) Inventors: Suhwuk KIM, Kawasaki (JP); Fumiaki KANAYAMA, Kawasaki (JP); Hiroki KUDO, Kawasaki (JP)

(73) Assignee: KABUSHIKI KAISHA TOSHIBA, Minato-ku (JP)

(21) Appl. No.: 15/266,580

(22) Filed: Sep. 15, 2016

(30) Foreign Application Priority Data
Mar. 16, 2016 (JP) 2016-052771

(51) Int. Cl. H04W 24/02; H04W 52/02

(52) U.S. Cl. CPC H04W 24/02; H04W 52/0206; H04L 49/1584

(57) ABSTRACT

A wireless communication device as an embodiment of the present invention configures a wireless mesh network with a plurality of other wireless communication devices and includes data storage and circuitry coupled with the data storage.

The data storage is configured to store data including a first data. The circuitry is configured to receive first reception data transmitted from one of the plurality of other wireless communication devices and to determine whether the first data matches with at least a part of the first reception data and to process to transmit at least a part of data stored in the data storage. The circuitry is configured not to process to transmit the first data determined to match at least the part of the first reception data.

### CROSS-REFERENCE TO RELATED APPLICATION (S)

This application is based upon and claims the benefit of priority from Japanese Patent Application No. 2016-052771, filed Mar. 16, 2016; the entire contents of which are incorporated herein by reference.

### FIELD

Embodiments described herein relate generally to a wireless communication device, a wireless communication method and a non-transitory computer readable medium.

### BACKGROUND

In a wireless mesh network where communication devices existing are mutually connected wirelessly, there may be a case where the wireless communication device cannot relay data due to interference of transmission waves, and thereby, the data cannot be transmitted to reach the destination. In order to prevent the case, the wireless communication device retransmits the data to realize the high reliability of communication. For example, there is a wireless communications system in which, in order to reduce electric power consumption, ACK (acknowledgment) is not transmitted even when data are received. As this system, a retransmission method is known, in which the wireless communication device as a transmission source (transmission source node) receives transmission radio waves from a wireless communication device of a transmission destination (transmission destination node), and in which the transmission source node confirms whether or not the data transmitted by the transmission source node are included in the received data from the transmission destination node, and thereby determines whether or not the data is to be retransmitted.

However, a problem may arise when the above-described retransmission method is applied in a network where the same data can be transmitted from two wireless communication devices to one wireless communication device. For example, there may be a case where, while one wireless communication device receives data from one of remaining two wireless communication devices, the one wireless communication device receives the data from the other of the remaining two wireless communication devices. In this way, in spite that all data are relayed, retransmission of the data is performed, so that the network load is increased.

### BRIEF DESCRIPTION OF THE DRAWINGS

FIG. 1 is a view for explaining a wireless mesh network;

FIG. 2 is a view for explaining wireless communication and operation of a wireless communication device;

FIG. 3 is a block diagram illustrating an example of a schematic configuration of a wireless communication device according to a first embodiment;

FIG. 4 illustrates an example of an outline flowchart of reception processing in a slot group of a child group;

FIG. 5 illustrates an example of an outline flowchart of data transmission processing;

FIG. 6 illustrates an example of an outline flowchart of reception processing in a slot group of a parent group;

FIG. 7 illustrates an example of an outline flowchart of additional transmission determination processing;

FIG. 8 is a block diagram illustrating an example of a schematic configuration of a wireless communication device according to a second embodiment;

FIG. 9 illustrates an example of an outline flowchart of data transmission processing according to the second embodiment;

FIG. 10 illustrates an example of an outline flowchart of reception processing in a slot group of a child group according to the second embodiment;

FIG. 11 is an outline flowchart of reception processing in a slot group of a parent group according to a third embodiment; and

FIG. 12 is a block diagram illustrating an example of a hardware configuration to realize a wireless communication device according to an embodiment of the present invention.

### DETAILED DESCRIPTION

Each of embodiments of the present invention is to suppress a network load in a wireless mesh network.

A wireless communication device as an embodiment of the present invention configures a wireless mesh network with a plurality of other wireless communication devices and includes data storage and circuitry coupled with the data storage.

The data storage is configured to store data including a first data. The circuitry is configured to receive first reception data transmitted from one of the plurality of other wireless communication devices and to determine whether the first data matches with at least a part of the first reception data and to process to transmit at least a part of data stored in the data storage. The circuitry is configured not to process to transmit the first data determined to match at least the part of the first reception data. Below, a description is given of embodiments of the present invention with reference to the drawings. The present invention is not limited to the embodiments.

### First Embodiment

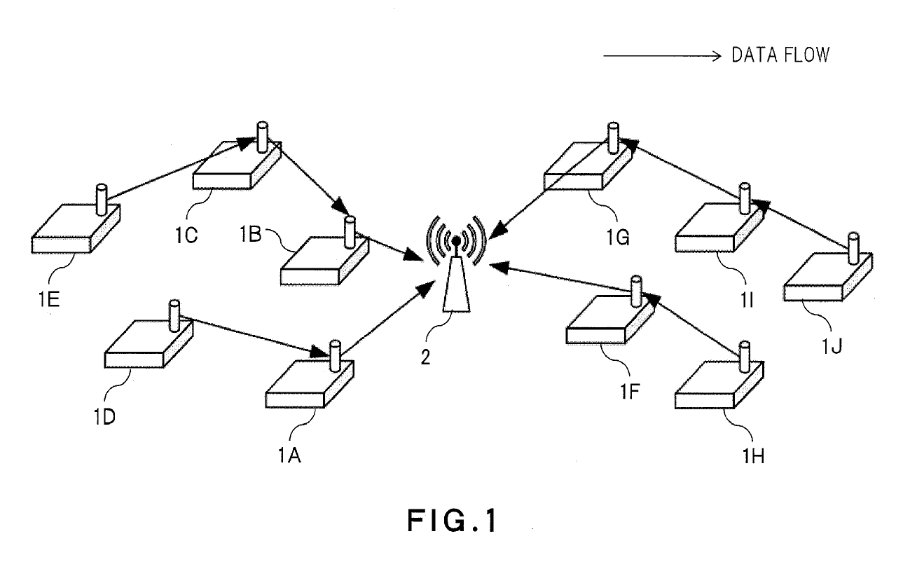

FIG. 1 is a view for explaining a wireless mesh network. It is assumed that the wireless mesh network is configured by a plurality of wireless communication devices 1 (1A to 1J), and a sink 2. As illustrated in FIG. 1, the wireless communication devices 1 are respectively denoted by alphabetic subscripts (A to J) to be distinguished from each other. It should be noted that the number of wireless communication devices 1 is not particularly limited. Further, other wireless communication devices except for the wireless communication device 1 and the sink 2 such as devices perform wireless communication with the wireless communication device 1 may exist in the wireless mesh network. Further, the wireless mesh network may be configured only by the wireless communication devices 1 without the specialized device like the sink 2. In this case, one of a plurality of wireless communication devices functions as the sink.

Each of the wireless communication devices 1 can perform wireless communication with other wireless communication devices 1 and the sinks 2.

Data transmitted by the plurality of wireless communication devices 1, which configure the wireless mesh network, are aggregated by the sink 2. The sink 2 may be a communication device connected to other network. The sink 2 is, for example, a Gateway. It should be noted that the sink 2 may have the same configuration as that of the wireless communication device 1.

Here, as illustrated by the arrows in FIG. 1, multi-hop communication is assumed. In multi-hop communication, each of the wireless communication devices 1 relays the data toward the sink 2 by a bucket relay method so that the data reach the sink 2. The wireless communication device 1 receives data from another wireless communication device 1 whose hop count from the sink 2 as the destination of the data is larger by one than own hop count. Then, the wireless communication device 1 transmits the received data to another wireless communication device 1 whose hop count from the sink 2 as the destination of the data is smaller by own hop count.

It should be noted that, in the following description, unless otherwise specifically indicated, the hop count means the hop count from the sink 2.

Further, in a case where hop count of another wireless communication device 1 or the sink 2 is less by one than that of the wireless communication devices 1, another wireless communication device 1 or the sink 2 is referred to as a parent node of the wireless communication devices 1. On the other hand, in a case where hop count of another wireless communication device 1 is more by one than that of the wireless communication devices 1, another wireless communication device 1 is referred to as a child node of the wireless communication devices 1.

Further, another wireless communication device 1 whose hop count is less than the wireless communication devices 1 is referred to as an upper node of the wireless communication devices 1, while another wireless communication device 1 whose hop count is more than the wireless communication devices 1 is referred to as a lower node of the wireless communication devices 1. Therefore, data of each of the wireless communication devices 1 are relayed from the child node to the parent node, and hence, the data flow from the lower node to the upper node.

It should be noted that, in the wireless mesh network of the present embodiment, data from at least one of the wireless communication devices 1 can reach the sink 2 via a plurality of paths. For example, at least one of the wireless communication devices 1, which configure the wireless mesh network, may have two or more parent nodes. At least one of the wireless communication devices 1, which configure the wireless mesh network, may have a plurality of child nodes.

Further, when a plurality of parent nodes exists, the group of the plurality of parent nodes is referred to as a parent group. Further, when a plurality of child nodes exists, the group of the plurality of child nodes is referred to as a child group. Further, a group consisting of the wireless communication devices 1, each of which has the same hop count, is referred to as an own group.

The wireless communication device 1 not only relays the received data (reception data) from a child node to a parent node, but also may transmit the data generated by the wireless communication device 1 to the parent node. At this time, the generation data generated by the wireless communication device 1 may be transmitted together with the received data from the child node. The data are generated by, for example, a determiner 104 described below.

A wireless communication method, at the time when the wireless communication device 1 performs transmission and reception of data addressed to the sink 2, will be described.

When the wireless communication device 1 has a plurality of parent nodes, the wireless communication device 1 can transmit data, addressed to the sink 2, to the plurality of parent nodes by multicast, broadcast, and the like. The parent node which has received the data may not return a response, such as ACK, to the wireless communication device 1 as the data transmission source.

The wireless communication device 1 performs transmission and reception of data by using wireless radio waves. Since the wireless radio waves are isotropically radiated, the wireless communication device 1 can receive radio waves radiated by other wireless communication devices 1 located in the vicinity of the wireless communication device 1. The wireless communication device 1 receives a wireless radio wave including data which parent node transmits to a parent node of the parent node. Thereby, the wireless communication device 1 can receive the transmission data of the parent node and determine that parent node relays the data to a parent node of the parent node.

Next, the timing of the wireless communications performed by the wireless communication device 1 will be described.

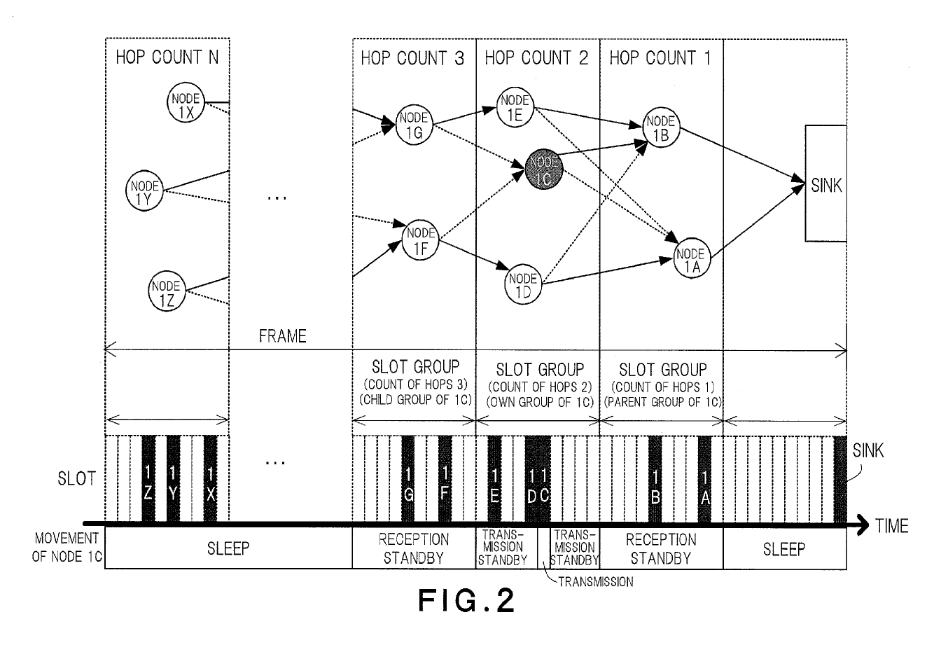

FIG. 2 is a view for explaining the wireless communication and operation of the wireless communication device 1. The upper portion of FIG. 2 illustrates an example of a configuration of the wireless mesh network. The lower portion of FIG. 2 illustrates a conceptual diagram of slots.

The wireless communication device 1 transmits data by a time-division communication method. In the time-division communication method, a predetermined transmission period is referred to as a frame. The frame includes a plurality of slot groups. The slot group includes a plurality of slots (unit periods). It should be noted that, here, the frame does not mean the frame that is a data unit in data communication.

A slot group is associated with a predetermined hop count. A slot is associated with the wireless communication device 1 whose hop count is the same as the predetermined hop count associated with the slot group including the slot.

In one frame, each of the slots is assigned to each of the wireless communication devices 1. For example, one slot is assigned to only one wireless communication device 1. In FIG. 2, the alphabet in the slot represents the alphabetic subscript of the wireless communication devices 1 assigned to the slot. The wireless communication device 1 can transmit data in the slot assigned thereto. In a slot group, one or more wireless communication devices 1 transmit data, their hop counts are the same.

For example, the first slot group in a frame is associated with the maximum hop count. Further, the hop count associated with a slot group is smaller by one than the hop count associated with another slot group immediately prior to the slot group. When it is explained based on the example of FIG. 2, the slot group which includes the wireless communication devices 1 each having the hop count N (N is an integer of 4 or more) is first. Further, the slot group which includes the wireless communication devices 1 each having the hop count 3, the slot group which includes the wireless communication devices 1 each having the hop count 2, and the slot group which including the wireless communication device 1 each having the hop count 1 are arranged in this order.

When the slot groups are arranged in this order, the data transmitted from each of the wireless communication devices 1 reach the sink 2 included in the last frame.

It should be noted that, the order of the slots, to which the wireless communication devices 1 are respectively signed, may be set freely in a slot group. Further, the number of the slots included in each of the slot groups may be equal to or greater than the number of the wireless communication devices 1 included in the each of the slot groups.

The wireless communication device 1 memorizes a slot assigned thereto, a slot groups assigned thereto, or both of the slots and the slot groups. Then, the wireless communication device 1 operates according to the slots or the slot groups.

For example, since data may be transmitted from each of the child nodes, the wireless communication device 1 is in a reception standby state in the slot associated with the each of the child nodes. In order to confirm transmission data from each of the parent nodes, the wireless communication device 1, is in the reception standby state in the slot associated with the each of the parent nodes.

The reception standby state is, for example, the state where the wireless communication device 1 supplies electric power to a wireless interface 101 and a transmission/reception processor 102 to receive transmission data from another wireless communication device 1 and a data classifier 103 can store the transmission data received from the another wireless communication devices 1. The wireless interface 101, the transmission/reception processor 102, and the data classifier 103 are described below.

The wireless communication device 1 performs transmission of data in the slot thereof. For example, the wireless communication device 1 is in a transmission standby state in the slots in the slot group of the own group except the slot thereof.

The transmission standby state is, for example, the state where the wireless communication device 1 interrupts electric power supply to the wireless interface 101 and the transmission/reception processor 102 and does not receive transmission data from another wireless communication device 1. Since the wireless communication device 1 does not receive data from another wireless communication device 1 and does not transmits data, the wireless communication device 1 may be in a sleep state suppressing electric power consumption, instead in the transmission standby state.

The wireless communication device 1 does not have to perform transmission and reception in the slot group which is not associated with each of itself, the parent nodes and the child nodes. Therefore, for example, the wireless communication device 1 can be in the sleep state suppressing electric power consumption in the slot group which is not associated with each of itself, the parent nodes and the child nodes.

In the sleep state of the wireless communication device 1, for example, the transmission/reception processor 102 included in the wireless communication device 1 is in the sleep state. The sleep state of the transmission/reception processor 102 means the state where the transmission/reception processor 102 does not perform transmission and reception. The sleep state is, for example, the state where electric power supply to the transmission/reception processor 102 is stopped and where the transmission/reception processor 102 does not transmit received data to the parent node by discarding the data.

As illustrated in the lower portion of FIG. 2, a wireless communication device 1C performs transmission in the slot of the wireless communication device 1C. Further, the wireless communication device 1C is in the transmission standby in the slots in the slot group of the own group except the slot thereof. The wireless communication device 1C is in the reception standby in each of the slot groups which are associated with the parent group of the wireless communication device 1C and the slot groups of the child group of the wireless communication device 1C. The wireless communication device 1C becomes in the sleep state in the slot groups which are not associated with the own group, the parent group and the child group of the wireless communication device 1C.

It should be noted that, the wireless communication device 1 may be in the sleep state in the slot in the slot group associated with the hop count of the child nodes except the slot of the child node. This is because the wireless communication device 1 does not have to receive data in relevant slots.

It should be noted that, the wireless communication device 1 may be in the sleep state in the slot in the slot group associated with the hop count of the parent nodes except the slot of the parent node. This is because the wireless communication device 1 does not have to receive data in relevant slots.

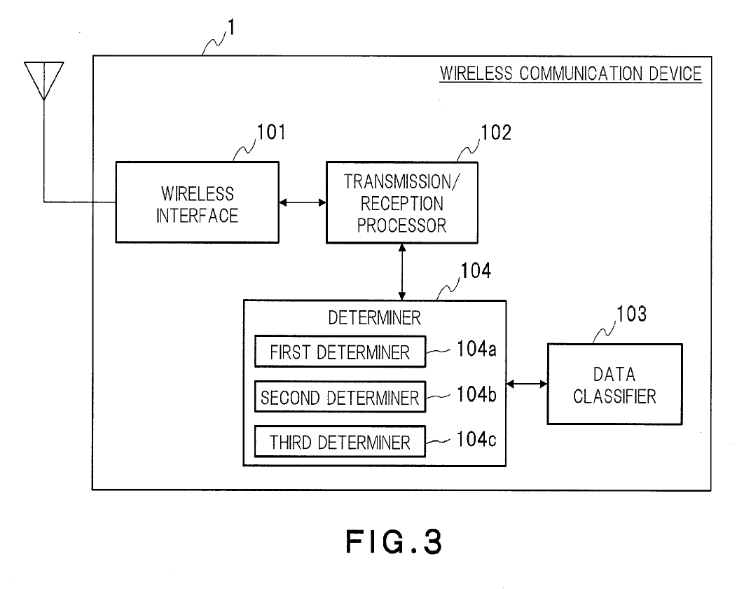

Next, a configuration of the wireless communication device 1 will be described. FIG. 3 is a block diagram illustrating an example of a schematic configuration of the wireless communication device 1 according to a first embodiment. The wireless communication device 1 according to the first embodiment includes the wireless interface 101, the transmission/reception processor 102, the data classifier (data storage) 103, and the determiner 104.

The wireless interface 101 performs transmission and reception of data to and from a parent node and a child node. As the wireless interface 101, various interfaces can be used, for example, which suit wireless standards such as wireless LAN like IEEE 802.11.a/b/g/n/ac and 920 MHz wireless. Especially, it is preferable that the interfaces are applicable to LAN (Local Area Network) or PAN (Personal Area Network).

The data classifier 103 stores storage data to be transmitted in the present frame or the next frame by the transmission/reception processor 102. The storage data includes a data part. Each of the data parts includes frame information. The storage data includes, for example, a first data part and a second data part. The first data part includes information about a frame (first frame). The second data part includes information about a frame (second frame). The information about the frame relates to, for example, a frame including the time when data are generated. Information about the frame relates to a frame including, for example, the time when data are first transmitted by one of the wireless communication devices in the wireless mesh network.

The transmission/reception processor 102 performs reception processing of received data transmitted from another wireless communication device 1. That is, the transmission/reception processor 102 performs reception processing of a signal inputted from the wireless interface 101 during the reception standby. Further, the transmission/reception processor 102 can perform transmission processing of at least a part of the storage data.

The storage data may include at least one of data generated by the wireless communication device 1 and data received from the child node. The wireless communication device 1 may further include storage. The storage may store, for example, the history of data transmitted and received by the wireless communication device 1. For example, the storage stores the storage data, and data to be transmitted by the wireless interface 101 after the storage data of the data classifier 103 is transmitted.

The data part may include, for example, data generated by different two wireless communication devices 1 in the first frame. The first data part and the second data part are, for example, each data transmitted at the first time in the first frame by the each of the different two wireless communication devices 1 in the wireless mesh network.

The classification of the storage data by the data classifier 103 will be described. The received data, received by the wireless communication device 1 from one or more child nodes, include identifiers for identifying a frame or derivation data for deriving the identifier. The data classifier 103 extracts the identifiers or the derivation data from the received data, and classifies the received data on the basis of the identifiers or the derivation data. The identifiers are, for example, serial numbers, or the like, of the flames. The derivation data are, for example, time, period and the like, included in the flame.

For example, in the first frame, data generated by the wireless communication device 1E with the hop count=3 are transmitted to the wireless communication device 1C with the hop count=2, which is the parent node. When data generated by the wireless communication device 1E are not received by the wireless communication device 1C in the first frame, the data are retransmitted from the wireless communication device 1E to the wireless communication device 1C in the second frame as the next frame. At this time, data generated in the second frame by the wireless communication device 1C may be transmitted together with the data generated by the wireless communication device 1E. For example, data generated by the wireless communication device 1E and data generated by the wireless communication device 1C are stored in the data classifier 103 of the wireless communication device 1C to be transmitted in the second frame. For example, data generated by the wireless communication device 1E includes information about the first frame, and the information is classified into the first data part by the data classifier 103. For example, data generated by the wireless communication device 1C includes data about the second frame, and the information is classified into the second data part by the data classifier 103.

When the wireless communication device 1C stores therein the data part including the information about the first frame and the data part including the information about the second frame, the first data includes the data generated by the wireless communication device 1E and the already sorted data. Further, the second data includes the data generated by the wireless communication device 1C and the already sorted data. It should be noted that, when the data is retransmitted, the identifier and the derivation data included in the data are not updated.

The data classifier 103 may attach a count value to the storage data or the data part. For example, the data classifier 103 attaches an initial value to data first transmitted by the wireless communication device 1 includes itself. Then, each time the transmission processing is performed by the transmission/reception processor 102 of the wireless communication device 1, the data classifier 103 attaches, to the data, the count value larger by one than the count value attached just before. For example, the count value means the number of times of transmission of data performed by the wireless communication device 1.

Further, the data classifier 103 may attach, to the storage data or the data part, a flag indicating whether or not the data are transmitted at this transmission opportunity (by the flame including the present time). The flag of the data received from the child node is initialized to FALSE by the wireless communication device 1. Then, the flag of the data part that is transmitted at this transmission opportunity is changed to TRUE by the wireless communication device 1. Flag of the data part not transmitted at this transmission opportunity remains FALSE. Further, when the frame number is changed after the flag is set to TRUE, the flag is initialized to FALSE. Further, the wireless communication device 1 may store only the data transmitted at this time in the storage instead of using the flag.

The determiner 104 determines whether or not the data part matches with at least a part of the received data from the parent node. This determination (referred to as transmission determination) is performed by, for example, a first determiner 104a included in the determiner 104.

For example, the received data received in the slot group of the parent node are compared with each of the data parts. When at least a part of the received data from the parent node matches with the data part, it is determined that the data part is not transmitted to the parent node. When at least a part of the received data from the parent node match with the data part, it is determined that the data part is transmitted to the parent node. To determine whether or not the data part matches with at least a part of the received data is referred to as the matching determination.

The transmission/reception processor 102 does not perform the transmission processing of the data part which is determined to match with at least a part of the received data by the determiner 104.

The transmission/reception processor 102 may perform the transmission processing of the first data part which is determined not to match with at least a part of the received data by the determiner 104. In a case where the storage data has a plurality of data parts, when the determiner 104 determines that some of the data parts do not match with at least a part of the received data and the others of the data part matches with at least a part of the received data, the transmission/reception processor 102 may not transmit the storage data.

In this case, the transmission/reception processor 102 inputs the second data part into the wireless interface 101 so that data can be transmitted in the assigned slot. The wireless interface 101 transmits the inputted second data part.

For example, after the wireless communication device 1C transmits the transmission data including the first data part to the wireless communication device 1A and the wireless communication device 1B which are the parent nodes, the wireless communication device 1C receives the received data from both the two parent nodes or one of the two parent nodes in the slot group of the parent nodes. When the first data are not included in the received data, the wireless communication device 1C determines to retransmit the first data part to both the parent nodes at the next transmission opportunity. When the first data are included in the received data, the wireless communication device 1C can determine that one or both of the wireless communication device 1A and the wireless communication device 1B relayed the first data, and hence, determines not to retransmit the first data at the next transmission opportunity. In this way, the transmission source of the received data which the wireless communication device 1C received may be any parent nodes.

Further, when determining that the first data are included in the received data from the parent nodes, in the subsequent frames, the wireless communication device 1C may not confirm whether or not the first data is included in the received data.

Further, when determining that the first data are included in the received data from the parent nodes, the wireless communication device 1C may assume that data other than the first data included in the storage data are also relayed, and then determine not to retransmit the other than the first data to the parent nodes. That is, when the first data part is included in the received data, the wireless communication device 1 may not transmit the storage data.

When determining not to transmit the data part, the wireless communication device 1 may delete the data part from the data classifier 103 according to the instruction of the determiner 104. Alternatively, the wireless communication device 1 may delete only the part having the TRUE flag of the data part determined not to transmit. The undeleted and remaining part of the data part may be transmitted in the next frame.

In this way, when one or more of the parent nodes relay the data part, the data part is not retransmitted, and thereby, the network load due to the retransmission can be suppressed.

Further, in the case where the parent node of the wireless communication device 1 has another child node, and where the wireless communication device 1 and the another child node of the parent node have the same data, when the another child of the parent node transmits the data to the parent node prior to the wireless communication device 1, the wireless communication device 1 is able not to transmit the data to the parent node. Therefore, the network load can be suppressed.

In the following, the method of additional transmission determination by the determiner 104 will be described.

(First Additional Transmission Determination)

The first additional transmission determination is performed by, for example, a second determiner 104b included in the determiner 104.

The second determiner 104b may determine whether or not the frame included in frame information which the data part has is older than a predetermined frame.

Even when it is determined by the first determiner 104a that the first data part does not match with at least a part of the received data, and when it is determined by the second determiner 104b that the first data part is older than the predetermined frame, the transmission/reception processor 102 does not perform the transmission processing of the first data part.

For example, the second determiner 104b may transmit, to the parent node, the data part having information about the frame newer than the predetermined frame. For example, when the storage data has the data part having frame information about a frame older than the predetermined frame, the second determiner 104b may determine not to transmit the storage data.

The second determiner 104b may determine whether or not to transmit the data part on the basis of the number of periods (frames) between the reference frame and the frame included in the information of the data part. For example, the reference frame is a frame including the time allowing the second determiner 104b to determine whether or not the data part is transmitted to the parent node. For example, the reference frame is the next flame as the frame including the time allowing the second determiner 104b to determine whether or not the data part is transmitted to the parent node.

For example, when the present frame is the 10-th frame, and when the data part including information on the first frame is stored in the data classifier 103, there may be a case where the data part does not need to be aggregated.

In this way, on the basis of the information about a frame included in the data part, the second determiner 104b may determine whether or not to transmit the data part to the parent node. On the basis of whether or not the difference between the reference frame and the frame included in the information of the data part is larger than a predetermined threshold, the second determiner 104b may determine whether or not to transmit the data part to the parent node. When the difference is larger than the predetermined threshold, the second determiner 104b may determine not to transmit the data part. Alternatively, when the storage data includes the data part including information about the frame whose difference with respect to the reference frame is larger than the threshold, the second determiner 104b may determine not to transmit the storage data.

By the first additional transmission determination, old data are made not to be transmitted, and hence, the network load can be reduced.

After the matching determination, the first additional transmission determination may be performed to the data part determined not to match with the at least a part of the received data. The transmission/reception processor 102 may perform transmission processing to the data which is determined to be transmitted by the matching determination and which is determined to be transmitted by the first additional transmission determination. The transmission/reception processor 102 may not perform transmission processing to the data which is determined not to be transmitted by the matching determination and which is determined not to be transmitted by the first additional transmission determination.

The first additional transmission determination may also be performed for determining whether or not to retransmit data when the data which is determined to be transmitted by the matching determination is transmitted by the wireless communication device 1 and is not received by the parent data.

(Second Additional Transmission Determination)

The second additional transmission determination may be performed on the basis of the count value. The second additional transmission determination may be performed by, for example, a third determiner 104c included in the determiner 104. The third determiner 104c may determine whether or not the number of times of the transmission processing of the data part performed by the transmission/reception processor 102 is larger than a first predetermined value.

The transmission/reception processor 102 does not perform transmission processing of a first data part when the first data part is determined not to match with at least a part of the received data by the first determiner 104a, and when the number of times of transmission of the first data part is determined to be larger than the first predetermined value by the third determiner 104c.

The third determiner 104c may determine to transmit the data to the parent node and make the transmission/reception processor 102 transmit the data part when the count value of the data part is less than the first predetermined value set beforehand. The third determiner 104c may determine not to transmit the data and make the transmission/reception processor 102 not to transmit the data when the count value is larger than the first predetermined value.

As described above, the count value represents the number of times of transmission of the data performed by the wireless communication device 1 and also the number of times of determination that the data do not reach the parent node.

For example, a case is considered in which the received data from the child node was received by the wireless communication device 1 and the transmission data is not received by the parent node since the state of radio wave between the wireless communication device 1 and the parent nodes is deteriorated. In this case, since the relay by the parent node cannot be confirmed, the storage data remain stored in the data classifier 103. However, since the data from the child node continue to be received by the wireless communication device 1, the amount of the storage data stored in the data classifier 103 is increased. Therefore, there is a possibility that a large amount of the transmitted data stored in the wireless communication device 1 are transmitted to the parent node and the network load is increased after the state of radio wave between the wireless communication device 1 and the parent nodes is recovered. However, when the second additional transmission determination is performed, data failed to be transmitted many times or a group consisting of the data is not transmitted to the parent node. Therefore, the network load can be suppressed. An example of the group is a communication time data group which is classified the received data into on the basis of information about the frame by the data classifier 103.

The threshold used to control the number of times of retransmission in the first and second additional transmission determinations may be set freely. The reliability of data transmission and the network load can be adjusted by appropriately determining the threshold according to the status of network.

For example, since, when the first predetermined value is set to be large, the number of times of retransmission is increased so that the possibility that the network load is increased becomes higher, but a reliability of aggregated data may be higher. Therefore, when the high reliability is required, the first predetermined value can be set large.

On the other hand, when the first predetermined value is set small, the number of times of retransmission is reduced so that the reliability is lowered, but the network load can be reduced. When the low load is required, the first predetermined value can be set small.

In this way, by appropriate changing the threshold, the present embodiment can be applied to various wireless mesh networks.

After it is determined whether or not the first data part and the second data part match with at least a part of the received data, the second additional transmission determination can be performed on the data part determined not to match with the at least a part of the received data. The transmission/reception processor 102 may perform transmission processing to the data which is determined to be transmitted by the matching determination and which is determined to be transmitted by the second additional transmission determination. The transmission/reception processor 102 may not perform transmission processing to the data which is determined not to be transmitted by the matching determination and which is determined not to be transmitted by the second additional transmission determination.

The second additional transmission determination may also be performed for determining whether or not to retransmit data when the data which is determined to be transmitted by the matching determination is transmitted by the wireless communication device 1 and is not received by the parent data. It should be noted that whether or not the determiner 104 performs the first and second additional transmission determinations may be set freely. Further, one or both of the first additional transmission determination and the second additional transmission determination may be performed. When both of the first additional transmission determination and the second additional transmission determination are performed, any of the additional transmission determinations may be performed first.

Next, an example of the process flow of the wireless communication device 1 according to the first embodiment will be described.

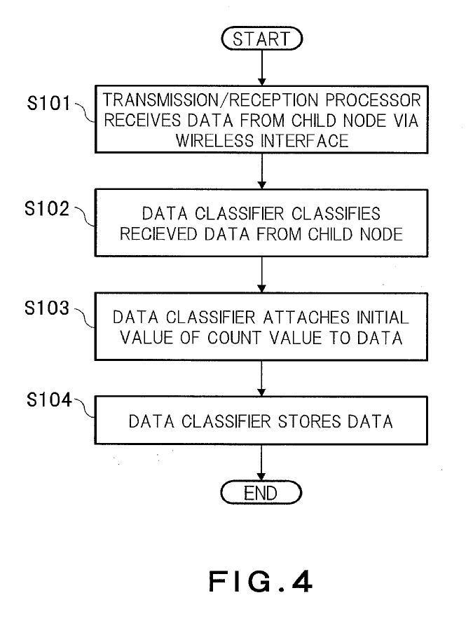

FIG. 4 is an outline flowchart of the reception processing in a slot group of a child group. The reception processing is started when the wireless communication device 1 is in the reception standby state in the slot group of the child group in order to receive the received data from the child node.

The transmission/reception processor 102 receives data from the child node via the wireless interface 101 (S101). The received data are transmitted to the data classifier 103. The data classifier 103 classifies the data on the basis of the identifier or the derivation data included in the data (S102). Further, the data classifier 103 may attach the initial value of the count value to the data (S103). The data classifier 103 stores the data attached the count value thereto in the storage (S104). The storage data includes the first data part and the second data part.

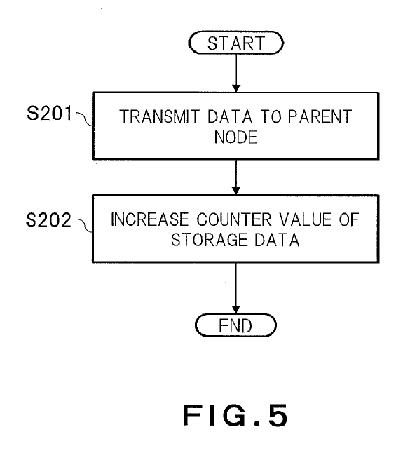

FIG. 5 illustrates an example of the outline flowchart of the data transmission processing. In order to transmit transmission data to the parent node, the wireless communication device 1 performs the data transmission processing between receiving data from the child node and actually transmitting the transmission data to the parent node. For example, the transmission processing starts when the wireless communication device 1 is in the transmission standby state in the slot group of the own group.

The transmission/reception processor 102 receives the storage data from the data classifier 103. Then, in order that the received storage data can be transmitted to the parent node in the slot assigned thereto, the transmission/reception processor 102 inputs transmission data into the wireless interface 101 (S201). After transmitting the transmission data, the data classifier 103 increases the count value of the storage data (S202).

It should be noted that, after the transmission data are transmitted, the data classifier 103 stores therein the transmission data until receiving the deletion instruction of the transmission data from the determiner 104.

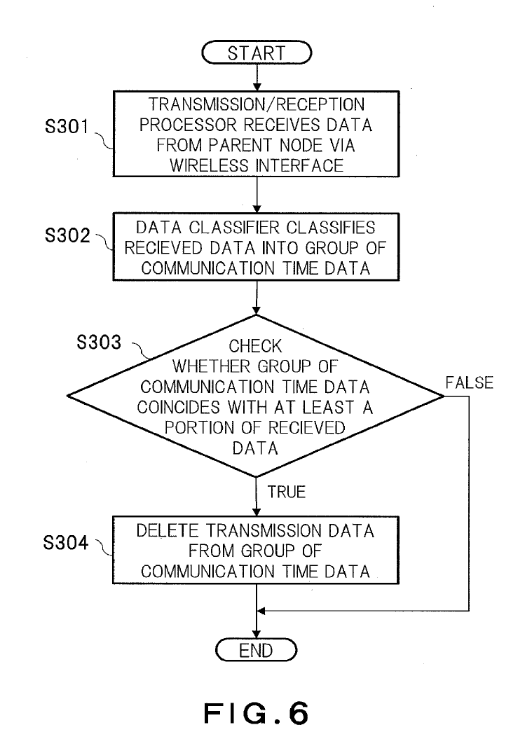

FIG. 6 illustrates an example of the outline flowchart of the reception processing in the slot group of the parent node. The wireless communication device 1 starts the reception processing in order to receive the received data from the parent node when the wireless communication device 1 is in the reception standby state in the slot group of the parent node.

In order that the wireless interface 101 receives the received data from the parent node, the transmission/reception processor 102 performs the reception processing (S301). When the received data are sent to the data classifier 103, the data classifier 103 may classify the received data into the group of communication time data group on the basis of information about the frame (S302).

The determiner 104 confirms whether or not the first data part and the second data part, which are included in the storage data, match with at least a part of the received data. When the first data part or the second data part match with the least the portion of the received data (TRUE in S303), the data classifier 103 may delete the matched first data part or the matched second data part from the storage area of the data classifier 103. The data classifier 103 may delete not only the matched first data part or the matched second data part, but also the transmission data from the storage area (S304). When the first data part and the second data part do not match with at least a part of the received data (FALSE in S303), the reception processing is ended.

It should be noted that, when received data are received from a plurality of parent nodes, the reception processing is performed for all of the received data.

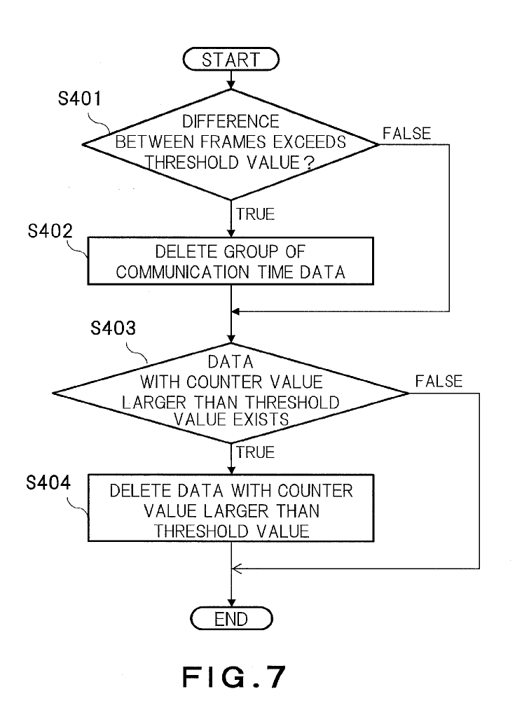

FIG. 7 illustrates an example of the outline flowchart of the additional transmission determination processing. This flow is the flow in a case the additional transmission determination is performed, and the process of this flow may not be performed. When the additional transmission determination processing is performed, the additional transmission determination processing may be performed in the retransmission standby state, or may be performed after the reception processing in the slot group of the parent node is performed. The time in which the additional transmission determination processing performs may be predetermined.

Further, the flowchart of FIG. 7 illustrates the case where both of the first additional transmission determination (S401 and S402) and the second additional transmission determination (S403 and S404) are performed.

The determiner 104 determines whether or not the difference between the reference frame and the frame about the data included in the storage data is larger than the threshold used for the first additional transmission determination. When the difference is larger than the threshold (TRUE in S401), the data classifier 103 deletes the group of communication time data group is related to the determined data (S402). When the difference is smaller than the threshold (FALSE in S401), the data classifier 103 omits the process of S402.

Next, the determiner 104 determines whether or not the count value of the data included in the storage data is larger than the threshold of the second additional transmission determination. When the count value is larger than the threshold (TRUE in S403), the data classifier 103 deletes the group of communication time data group is related to the determined data (S404). When the count value is smaller than the threshold (FALSE in S403), the data classifier 103 omits the process of S404.

### Second Embodiment

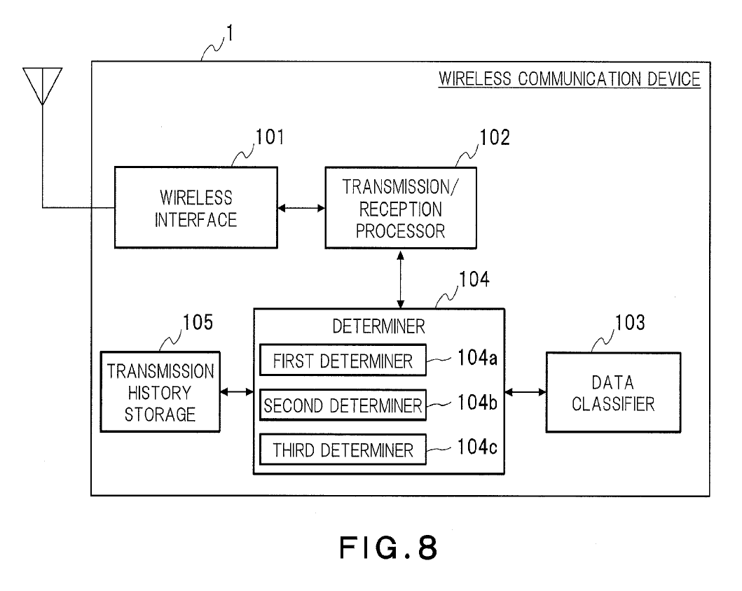

FIG. 8 is a block diagram illustrating an example of a schematic configuration of a wireless communication device 1 according to a second embodiment. The wireless communication device 1 according to the second embodiment is different from that according to the first embodiment in that transmission history information storage 105 is further provided. The transmission history information storage 105 may be the storage of the first embodiment (the data classifier 103). Description that overlaps the first embodiment will be omitted.

The second embodiment relates to whether data received from the child node are stored in the data classifier 103. In the wireless mesh network according to the second embodiment, the parent node of a certain wireless communication device 1 has no child nodes other than the certain wireless communication device.

The transmission history information storage 105 stores information about the data transmission-processed by the transmission/reception processor 102. The information about the data transmission-processed by the transmission/reception processor 102 may be information for determining whether or not the received data from the child node matches with at least a part of the transmission data which have been transmitted until the present time by the transmission/reception processor 102 itself. The information about the data transmission-processed may be the transmission data themselves or the identifier representing the transmission data. Here, the information about the data transmission-processed which stored by the transmission history information storage 105, that is information about the data transmission-processed by the transmission/reception processor 102 is referred to as transmission history information. The transmission/reception processor 102 performs reception processing of the received data transmitted from the child node.

The determiner 104 (first determiner 104a) determines on the basis of the transmission history information whether or not the transmission processing to data part included in the received data from the child node is performed by the transmission/reception processor 103. The data part included in the received data has information about the frame.

The data classifier 103 stores the data part that is determined not to be transmission-processed by the transmission/reception processor 102.

First, the case where the wireless communication device 1 according to the second embodiment transmits the transmission data to the parent node will be described.

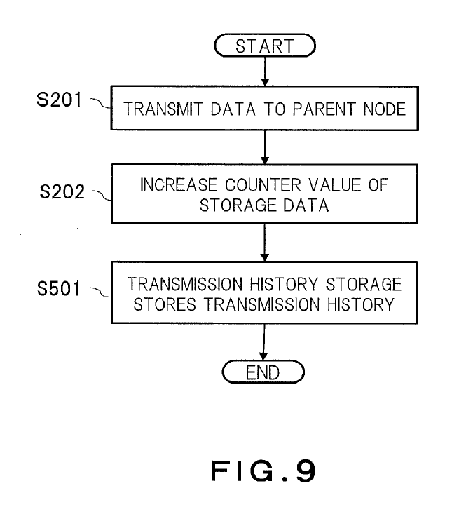

FIG. 9 illustrates an example of an outline flowchart of the data transmission processing according to the second embodiment. The processes from S201 to S202 are the same as those in the first embodiment. After the process of S202, the transmitted transmission data is transmitted to the transmission history information storage 105, and the transmission history information storage 105 stores the transmission history information (S501).

Next, the case will be described where the wireless communication device 1 according to the second embodiment receives the received data from the child node after transmitting the transmission data to the parent node.

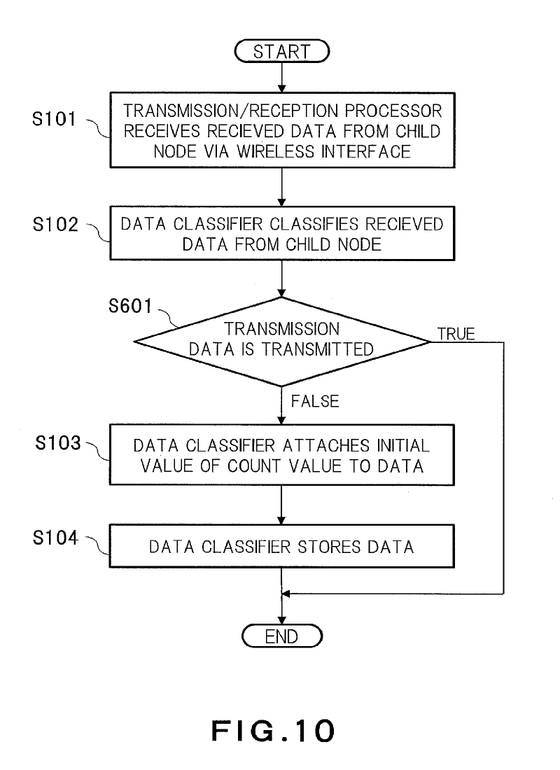

FIG. 10 illustrates an example of an outline flowchart of the reception processing in the slot group of the child node according to the second embodiment. The processes of S101 and S102 are the same as those in the first embodiment. After the process in S102, the determiner 104 confirms whether or not the first data part and the second data part are transmitted on the basis of the transmission history information of the transmission history information storage 105 (S601). When it is confirmed that the transmission history information about the first data part and the second data part is stored in the transmission history information storage 105 (TRUE of S601), it is confirmed that the relevant first data part and the second data part from the child node are already relayed to the parent node, and hence, the determiner 104 does not transmit the relevant received data to the parent node. In other word, when data of the first data part and the second data part which are included in the received data from the child node is included in the transmission history information, the data are not stored in the data classifier 103.

On the other hand, when it is confirmed that data of at least a part of the received data from the child node are not already transmitted since the transmission history information about the data are not stored in the transmission history information storage 105 (FALSE in S601), the transmission history information storage 105 attaches increased count value to the data (S103) and stores the data with the increased count value in the data classifier 103 (S104). After that, the storage data are transmitted to the parent node. For example, when the determiner 104 determines that the first data part is already transmitted and the second data part is not transmitted, the transmission/reception processor 102 stores the second data part in the data classifier 103 and does not store the first data part in the data classifier 103.

In this way, before the wireless communication device 1 relays the received data from the child node to the parent node, the wireless communication device 1 can confirm whether or not the received data are already transmitted. Thereby, the wireless communication device 1 does not transmit the already relayed data to the parent again, and hence, the network load can be suppressed.

### Third Embodiment

In the present embodiment, the wireless communication device 1 includes the transmission history information storage 105 similarly to the second embodiment. The present embodiment relates to the determination of whether or not the storage data of the data classifier 103 are transmitted to the parent node.

For example, the wireless communication device 1C transmits data to the wireless communication device 1B, and the wireless communication device 1B receives the data and transmits the data to the sink 2. Here, when, in spite of that the wireless communication device 1B relayed the data, the wireless communication device 1C could not receive radio waves for relaying the data (relay radio waves) from the wireless communication device 1B, the wireless communication device 1C retransmits the data. Since the wireless communication device 1B stores the transmission history information about the relayed data, the wireless communication device 1B does not relay the data retransmitted from the wireless communication device 1C.

Here, in spite that the wireless communication device 1C received the relay radio waves of next transmission (next relay radio waves) from the wireless communication device 1B, the retransmitted data are not included in the next relay radio waves. Therefore, the wireless communication device 1C may repeat the retransmission of the data.

In the present embodiment, when the wireless communication device 1C determines whether or not the data are transmitted on the basis of the transmission history information, the wireless communication device 1C determine whether or not a portion but all of the storage data are to be transmitted to the parent node. The storage data includes, for example, a plurality of data parts.

For example, a part of the data parts are data generated by the determiner 104 of the wireless communication device 1, and the remaining part of the data parts is data generated by the other wireless communication devices 1. When the determiner 104 determines that the part of the data parts matches with at least a part of the received data from the parent node and that the remaining part of the data parts does not match with at least a part of the received data, the transmission/reception processor 102 does not transmit the storage data.

For example, a part of the data parts are included in the data of last transmitted by the transmission/reception processor 102, and are not included in the data transmitted before the last transmission. For example, the remaining part of the data parts is data transmitted a plurality of times by the transmission/reception processor 102. When the determiner 104 determines that a part of the data part s match with at least a part of the received data from the parent node and the remaining part of the data part s does not match with at least a part of the received data from the parent node, the transmission/reception processor 102 does not transmit the storage data.

For example, the case where the parent node of a certain wireless communication device 1 does not have child node except for the certain wireless communication device 1 will be described. The certain wireless communication device 1 transmits the storage data including a first data part and a second data part to the parent node. After that, the certain wireless communication device 1 receives data from the parent node. For example, the first data part is data transmitted first to the parent node from the certain wireless communication device 1. For example, the second data part is data transmitted a plurality of times from the certain wireless communication device 1 to the parent node. When the first data part matches with at least a part of the received data from the parent node, and even when the second data part does not match with at least a part of the received data from the parent node, the certain wireless communication device 1 does not retransmit the storage data. For example, the certain wireless communication device 1 can delete the storage data from the data classifier 103. Thereby, it is possible to prevent the repeated retransmission of relayed data.

For example, the case where the parent node of a certain wireless communication device 1 has one or more child nodes in addition to the certain wireless communication device 1 will be described. The certain wireless communication device 1 receives data from the parent node. For example, the first data part is data generated by the certain wireless communication device 1. For example, the second data part is data generated by the other wireless communication devices 1 each having the hop count larger than the hop count of the certain wireless communication device 1. When the first data part matches with at least a part of the received data from the parent node, and even when the second data part does not match with at least a part of the received data from the parent node, the wireless communication device 1 does not retransmit the storage data. For example, the wireless communication device 1 can delete the storage data from the data classifier 103. Thereby, it is possible to prevent the repeated retransmission of relayed data.

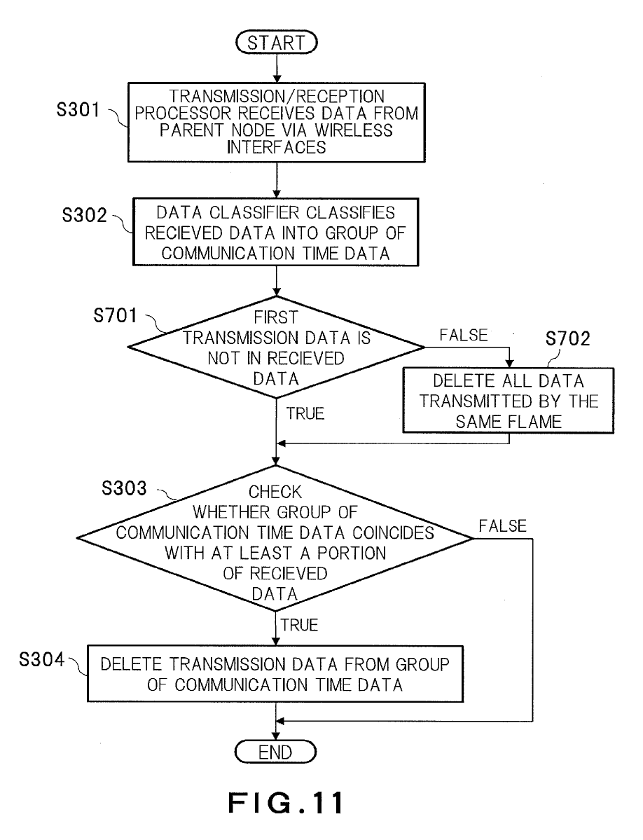

FIG. 11 is an outline flowchart of reception processing in the slot group of the parent group according to the second embodiment. The processes of S301 and S302 are the same as those of the first embodiment. After the process of S302, the determiner 104 determines whether or not data, which generated by the wireless communication device 1 or first transmitted by the wireless communication device 1, of the storage data is included in the received data from the parent node. For example, when the first data part included in the storage data are the data first transmitted by the wireless communication device 1 and the second data part are data transmitted a plurality of times by the wireless communication device 1, the flow is described as follows.

When the first data part is included in the received data from the parent node (FALSE in S701), the determiner 104 deletes the storage data from the data classifier 103 (S702). After the process of S702, the process proceeds to S303. It should be noted that the flow may be ended.

When the first data part is not included in the received data from the parent node (TRUE in S701), similarly to the first embodiment, it is determined whether or not the second data part is included in the received data from the parent node. The subsequent processes of S303 and S304 are also the same as the first embodiment.

It should be noted that, in the process of S701, the determiner 104 may determine whether or not newly generated data are not included in the received data. For example, when the first data part is not included in the received data from the parent node, and when newly generated data are not included in the received data, the process may proceed to S303. When at least newly generated data are included in the received data, the process may proceed to S702, and the storage data may be deleted from the data classifier 103. After the storage data are deleted, the process may proceed to S303, or the flow may be ended. For example, in a case where a certain wireless communication device 1 could not transmitted data as the child node to parent node for some reason, and where another child node of the parent node transmitted the data, the parent node has already relayed the data, and hence, the certain wireless communication device 1 does not have to retransmit the data. Determining that newly generated data are not included in the received data, the wireless communication device 1 can respond such the case.

As described above, according to the third embodiment, the wireless communication device 1 can reduce the amount of data transmitted to the parent node on the basis of the transmission history information of the transmission history information storage 105, and thereby can suppress the network load.

Further, in the third embodiment, when the wireless communication device 1 cannot confirm the relay of the parent node, it is possible to prevent that the retransmission to the parent node is repeated.

Each process in the embodiments described above can be implemented by software (program). Thus, the wireless communication device 1 in the embodiments described above can be implemented using, for example, a general-purpose computer apparatus as basic hardware and causing a processor mounted in the computer apparatus to execute the program.

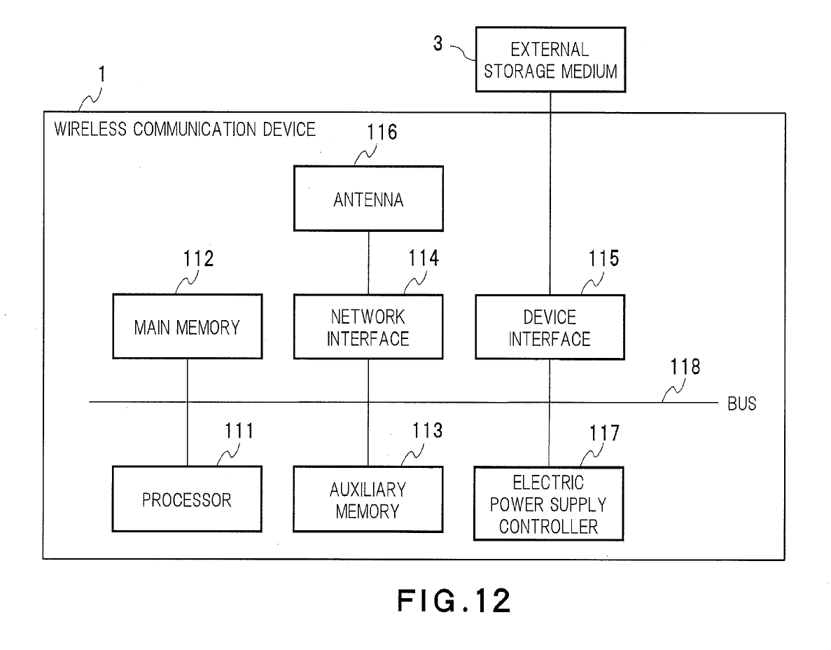

FIG. 12 is a block diagram illustrating an example of a hardware configuration which realizes the wireless communication device 1 according to an embodiment of the present invention. The wireless communication device 1 can be realized as a computer device including a processor 111, a main memory 112, an auxiliary memory 113, a network interface 114, a device interface 115, an antenna 116, and an electric power supply controller 117 which are mutually connected via a bus 118.

The electric power supply controller 117 is configured to set the wireless communication device 1 in the sleep state. Here, the electric power supply controller 117 is provided as an independent device, but the function of the electric power supply controller 117 may be mounted to the processor 111 or the network interface 114.

The processor 111 reads the program from the auxiliary memory 113, and executes the program by developing the program on the main memory 112, so that the functions of the transmission/reception processor 102, the data classifier 103, and the determiner 104 are realizable.

The wireless communication device 1 of the present embodiment may be realized in such a manner that the program executed in the wireless communication device 1 is installed in the computer device beforehand, or that the program is stored in a storage medium, such as CD-ROM, or is distributes via a network, and is appropriately installed in the computer device.

The network interface 114 is an interface which is connected to the network via the antenna 116. The wireless interface 101 may be realized by the network interface 114. Here, only one network interface is illustrated, but a plurality of network interfaces may be mounted.

The device interface 115 is an interface which is connected to a device, such as an external storage medium 3. The external storage medium 3 may be an arbitrary recording medium, such as HDD, CD-R, CD-RW, DVD-RAM, DVD-R, and SAN (Storage area network). The transmission history information storage 105 may be connected, as the external storage medium 3, to the device interface 115.

The main memory 112 is a memory temporarily storing instructions and various data, and the like, which are executed by the processor 111. The main memory 112 may be a volatile memory, such as DRAM, or a nonvolatile memory, such as MRAM. The auxiliary memory 113 is storage which permanently stores the program, data, and the like. The auxiliary memory 113 is, for example, HDD, SSD, or the like. The data which are stored in the data classifier 103, the transmission history information storage 105, and the like, are stored in the main memory 112, the auxiliary memory 113, or the external storage medium 3.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A wireless communication device configuring a wireless mesh network with a plurality of other wireless communication devices, the wireless communication device comprising:
a data storage configured to store data including a first data; and
circuitry coupled with the data storage and configured to:
receive first reception data transmitted from one of the plurality of other wireless communication devices,
determine whether the first data matches with at least a part of the first reception data; and
process to transmit at least a part of data stored in the data storage,
wherein the circuitry is configured not to process to transmit the first data determined to match at least the part of the first reception data.

2. The wireless communication device according to claim 1, wherein the circuitry performs transmission processing of the first data determined not to match with at least a part of the first reception data by the circuitry.

3. The wireless communication device according to claim 1, wherein:
the data stored in the data storage includes the two first data; and
when circuitry determines that one of the first data does not match with at least a part of the first reception data and the other of the first data matches with at least a part of the first reception data, the circuitry does not transmit the data stored in the data storage.

4. The wireless communication device according to claim 2, wherein:
the first data includes information about time;
the circuitry determines whether or not the information about time is older than a predetermined time; and
the circuitry does not perform transmission processing of the first data determined not to match with at least a part of the first reception data by the circuitry and determined which is older than the predetermined time by the circuitry.

5. The wireless communication device according to claim 2, wherein:
the circuitry determines whether or not the number of times of transmission processing of the first data performed by the circuitry is larger than a first predetermined value; and
the circuitry does not perform transmission processing of the first data determined not to match with at least a part of the first reception data by the circuitry and the number of times of which is determined to be larger than the first predetermined value by the circuitry.

6. The wireless communication device according to claim 1, further comprising
transmission history information storage configured to store transmission history information about data transmission-processed by the circuitry,
wherein:
the circuitry performs the reception processing of second reception data transmitted from another one of the plurality of other wireless communication devices;
the circuitry determines whether or not a second data included in the second reception data is transmission-processed by the circuitry on the basis of the transmission history information; and
the data storage stores the second data determined to be not performed transmission processing of the circuitry by the circuitry.

7. The wireless communication device according to claim 1, wherein:
the data stored in the data storage includes the two first data;
one of the first data is data generated by the circuitry, and the other of the first data is not data generated by the circuitry; and
when the circuitry determines that the one of the first data matches with at least a part of the first reception data and that the other of the first data does not match with at least a part of the first reception data, the circuitry does not transmit the data stored in the data storage.

8. The wireless communication device according to claim 1, wherein;
the data stored in the data storage includes the two first data;
one of the first data is included in data finally transmitted by the circuitry and is not included in data transmitted before the last data, and the other of the first data is data transmitted a plurality of times by the circuitry; and
when the circuitry determines that the one of the first data matches with at least a part of the first reception data and that the other of the first data does not match with at least a part of the first reception data, the circuitry does not transmit the data stored in the data storage.

9. A wireless communication method executed by a wireless communication device configuring, together with a plurality of other wireless communication devices, a wireless mesh network, the wireless communication method comprising:
storing data including a first data;
receiving first reception data transmitted from one of the plurality of other wireless communication devices;
determining whether or not the first data matches with at least a part of the first reception data;
processing to transmit at least a part of data stored in the data storage; and
not processing to transmit the first data determined to match at least the part of the first reception data.

10. A non-transitory computer readable medium having a program stored therein which causes a wireless communication device configuring, together with a plurality of other wireless communication devices, a wireless mesh network, when executed, to perform processes comprising:
storing data including a first data;
receiving first reception data transmitted from one of the plurality of other wireless communication devices;
determining whether or not the first data matches with at least a part of the first reception data;
processing to transmit at least a part of data stored in the data storage; and
not processing to transmit the first data determined to match at least the part of the first reception data.

11. A wireless communication device configuring a wireless mesh network with a plurality of other wireless communication devices, the wireless communication device comprising:
a data storage configured to store data including a plurality of first data; and
circuitry coupled with the data storage and configured to:
receive first reception data transmitted from one of the plurality of other wireless communication devices; and
process to transmit at least a part of data stored in the data storage,
wherein:
the circuitry is configured to process to transmit first data not matching with at least a part of the first reception data among the plurality of the first data; and
the circuitry is configured not to process to transmit first data matching with at least a part of the first reception data among the plurality of the first data.

12. A wireless communication system comprising a plurality of the wireless communication devices according to claim 11.
